(19) United States
(12) Patent Application Publication
(10) Pub. No.: US 2010/0013269 A1
(43) Pub. Date: Jan. 21, 2010

(54) B-pillar having electronic control device, and/or method of making the same

(75) Inventor: Steven P. Mcenany, Macomb, MI (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 12/219,065

(22) Filed: Jul. 15, 2008

(51) Int. Cl. B60R 27/00; B23P 17/00; G06F 17/00

(52) U.S. Cl. 296/193.06; 296/203.03; 29/592.1; 701/1

(57) ABSTRACT

Certain example embodiments relate to a vehicle pillar (e.g., a B-pillar) electronic control device, and/or a method of making the same. A pillar is molded, with the pillar being at least initially clear. An inner surface of the pillar is painted a desired color. Areas of the paint are laser etched away from the inner surface of the pillar to form one or more symbols. At least some of the symbols correspond to control buttons and/or indicators. Each symbol is substantially flush with an outer surface of the pillar. Control electronics are inserted into a recess formed in the pillar, with the recess being formed in the inner surface of the pillar. The control electronics are sealed in the recess via an adhesive. The adhesive may have a foam core. The pillar may be substantially impermeable with respect to debris and/or other elements.

### FIELD OF THE INVENTION

Certain example embodiments of this invention relate to an electronic control device for a vehicle, and/or a method of making the same. More particularly, certain example embodiments relate to a vehicle pillar (e.g., a B-pillar) electronic control device, and/or a method of making the same. In certain example embodiments, a user may control various vehicle functions via the B-Pillar electronic control device via a control area of the B-Pillar electronic control device that is substantially flush with the B-Pillar itself. In certain example embodiments, the B-Pillar may be made from an acrylic whose inner surface has been painted, with some of the painting being laser-etched away so as to create the appearance of one or more symbols. In certain example embodiments, the B-Pillar may be substantially impermeable to debris and/or other elements.

### BACKGROUND AND SUMMARY OF EXAMPLE EMBODIMENTS OF THE INVENTION

Keyless entry systems for vehicles (e.g., cars, trucks, and the like) are known. The term “keyless entry system,” however, is something of a misnomer, since some keyless entry systems may be used to accomplish more than merely locking and unlocking one or more doors. That is, some keyless entry systems enable a user to also open a trunk lid or gas cover door, turn on or off the vehicle itself, activate lights, and/or accomplish other purposes.

Keyless entry systems often are provided on the exterior of the vehicle, typically proximate to the handle of the car. More particularly, keyless entry systems usually are located proximate to where a key would be inserted into a lock. Typically, the keyless entry systems include buttons that project outwardly from the vehicle. A user may press the buttons to instruct properly configured control electronics connected to the buttons to take the desired action. For instance, using a conventional keyless entry system, a user may enter a numeric, alphanumeric, or other suitable code via extruded buttons to, for example, unlock all car doors and turn on the vehicle.

Although such keyless entry systems have been successfully employed, further modifications are still possible and/or desired. For example, the inventor of the instant application has discovered that it would be desirable to create a keyless entry system that has a cleaner appearance that is smooth and consistent with the exterior of the vehicle. The inventor of the instant application also has discovered that, to this end, it would be desirable to provide an electronic control device that is substantially flush with the exterior of the vehicle and that is substantially impermeable to debris and other elements.

Certain example embodiments provide these and/or other advantageous aspects. Indeed, one aspect of certain example embodiments relates to an electronic means of locking and/or unlocking doors and providing other features. The electronic means may be located within a B-Pillar in certain example embodiments, giving the vehicle a cleaner exterior appearance. That is, the exterior surface of the B-Pillar may have a smooth, consistent appearance, with numbers, graphics, or other symbols effectively hidden in the substrate finish. When the electronics are activated (e.g., by touch control), electronic lights may illuminate the etched numbers, thereby allowing the user to key in a code to activate the locking mechanisms and/or other features.

In certain example embodiments of this invention, a method of making an electronic control device for a vehicle is provided. A pillar is molded, with the pillar being at least initially clear. An inner surface of the pillar is painted a desired color. Areas of the paint are laser etched away from the inner surface of the pillar to form one or more symbols. At least some of said symbols correspond to control buttons and/or indicators. Each said symbol is substantially flush with an outer surface of the pillar. Control electronics are inserted into a recess formed in the pillar, with the recess being formed in the inner surface of the pillar. The control electronics are sealed in the recess via an adhesive.

In certain example embodiments, an electronic control device for a vehicle is provided. A pillar is initially molded clear and has an inner surface thereof painted a desired color. At least some of the paint is etched away to form one or more symbols. At least some of said symbols correspond to control buttons and/or indicators. A recess is formed in the inner surface of the pillar. Control electronics are inserted into the recess, with the control electronics being configured to control features of the vehicle in response to a code input using the control buttons via the control electronics. An adhesive is arranged to seal the control electronics in the recess. Each said symbol is substantially flush with an outer surface of the pillar.

In certain example embodiments, a pillar for a vehicle including an electronic control device is provided. The pillar is initially molded clear and has an inner surface thereof painted a desired color. At least some of the paint is etched away to form one or more symbols, with at least some of said symbols corresponding to control buttons and/or indicators. The pillar comprises a recess formed in the inner surface of the pillar. Control electronics are inserted into the recess, with the control electronics being configured to control features of the vehicle in response to a code input using the control buttons via the control electronics. An adhesive is arranged to seal the control electronics in the recess. Each said symbol is substantially flush with an outer surface of the pillar. The pillar is formed from acrylic.

In certain example embodiments, a vehicle comprising a pillar and an electronic control device for the vehicle is provided. The pillar is initially molded clear and has an inner surface thereof painted a desired color. At least some of the paint is etched away to form one or more symbols. At least some of said symbols correspond to control buttons and/or indicators. The pillar comprises a recess formed in the inner surface of the pillar. Control electronics are inserted into the recess, with the control electronics being configured to control features of the vehicle in response to a code input using the control buttons via the control electronics. An adhesive is arranged to seal the control electronics in the recess. Each said symbol is substantially flush with an outer surface of the pillar. The pillar is formed from acrylic.

The features, aspects, advantages, and example embodiments described herein may be combined to realize yet further embodiments.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is an illustrative view of an outer surface of a B-Pillar in accordance with an example embodiment;

FIG. 2 is an illustrative view of an inner surface of a B-Pillar in accordance with an example embodiment;

FIG. 3 is a vehicle including a B-Pillar in accordance with an example embodiment;

FIG. 4 shows the peel strength of an example adhesive for a 90 degree peel at various conditions; and

FIG. 5 is a flowchart showing an illustrative process for making a B-Pillar electronic device in accordance with an example embodiment.

### DETAILED DESCRIPTION OF EXAMPLE EMBODIMENTS OF THE INVENTION

In certain example embodiments of this invention, a method of making an electronic control device for a vehicle is provided. A pillar is molded, with the pillar being at least initially clear. An inner surface of the pillar is painted a desired color. Areas of the paint are laser etched away from the inner surface of the pillar to form one or more symbols. At least some of said symbols correspond to control buttons and/or indicators. Each said symbol is substantially flush with an outer surface of the pillar. Control electronics are inserted into a recess formed in the pillar, with the recess being formed in the inner surface of the pillar. The control electronics are sealed in the recess via an adhesive.

In certain example embodiments, an electronic control device for a vehicle is provided. A pillar is initially molded clear and has an inner surface thereof painted a desired color. At least some of the paint is etched away to form one or more symbols. At least some of said symbols correspond to control buttons and/or indicators. A recess is formed in the inner surface of the pillar. Control electronics are inserted into the recess, with the control electronics being configured to control features of the vehicle in response to a code input using the control buttons via the control electronics. An adhesive is arranged to seal the control electronics in the recess. Each said symbol is substantially flush with an outer surface of the pillar.

In certain example embodiments, a pillar for a vehicle including an electronic control device is provided. The pillar is initially molded clear and has an inner surface thereof painted a desired color. At least some of the paint is etched away to form one or more symbols, with at least some of said symbols corresponding to control buttons and/or indicators. The pillar comprises a recess formed in the inner surface of the pillar. Control electronics are inserted into the recess, with the control electronics being configured to control features of the vehicle in response to a code input using the control buttons via the control electronics. An adhesive is arranged to seal the control electronics in the recess. Each said symbol is substantially flush with an outer surface of the pillar. The pillar is formed from acrylic.

In certain example embodiments, a vehicle comprising a pillar and an electronic control device for the vehicle is provided. The pillar is initially molded clear and has an inner surface thereof painted a desired color. At least some of the paint is etched away to form one or more symbols. At least some of said symbols correspond to control buttons and/or indicators. The pillar comprises a recess formed in the inner surface of the pillar. Control electronics are inserted into the recess, with the control electronics being configured to control features of the vehicle in response to a code input using the control buttons via the control electronics. An adhesive is arranged to seal the control electronics in the recess. Each said symbol is substantially flush with an outer surface of the pillar. The pillar is formed from acrylic.

As alluded to above, certain example embodiments relate to a keyless entry system that has a cleaner appearance that is smooth and consistent with the exterior of the vehicle, and/or an electronic control device that is substantially flush with the exterior of the vehicle and that is substantially impermeable to debris and other elements. Such a keyless entry system or electronic control device may be located on the B-Pillar of a vehicle, for example. As will be recognized by car stylists, enthusiasts, and/or others, the term “A-Pillar” is used to refer to the shaft of material that supports a vehicle's windshield on either of the windshield frame. Each subsequent substantially vertical structural member in the vehicle's “greenhouse” is denoted with a successive letter of the alphabet. Thus, the B-Pillar of a vehicle refers to the first substantially vertical 'structural member in a vehicle's greenhouse subsequent to the substantially vertical support adjacent to the vehicle's windshield. As such, the B-Pillar essentially is located on the door of a passenger vehicle. The driver's and/or passenger's door may be made to include a means of locking/unlocking doors, turning on interior lighting, opening the truck lid, and/or providing other features, with or without the use of keys or a remote transmitter.

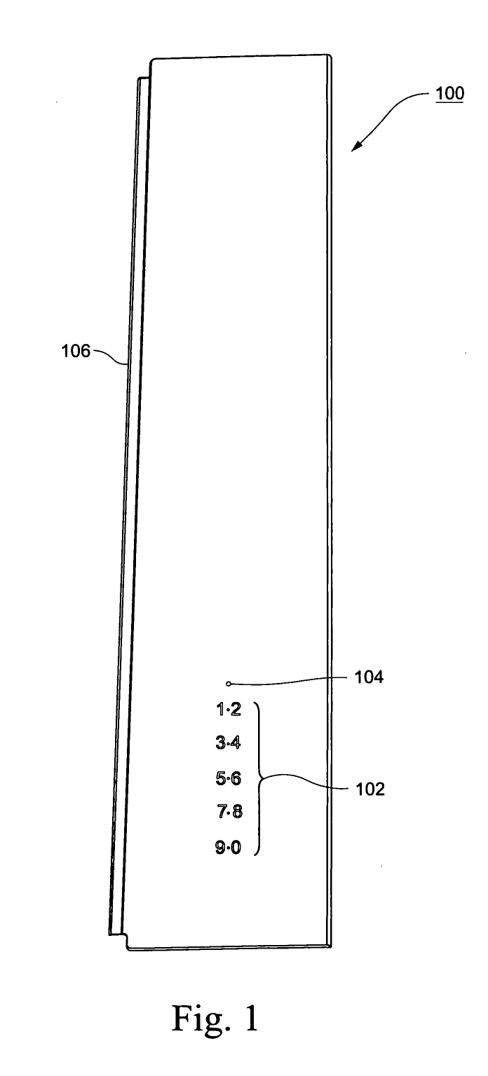

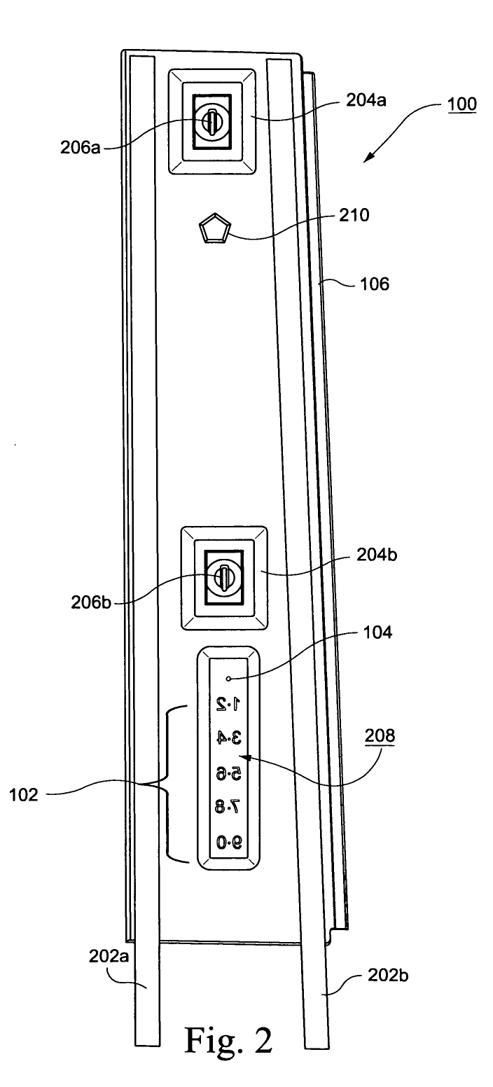

Referring now more particularly to the drawings in which like references numerals indicate like components throughout the several views, FIG. 1 is an illustrative view of an outer surface of a B-Pillar in accordance with an example embodiment, and FIG. 2 is an illustrative view of an inner surface of a B-Pillar in accordance with an example embodiment.

The B-Pillar substrate 100 is injection molded using a clear material such as, for example, Plexiglas or other acrylic material, and/or the like. In certain example embodiments, it may be possible and/or advantageous to use the same type of acrylic used in the construction of headlamps and/or tail lamps. For example, using the material already known to be used in and acceptable for automotive applications may be advantageous, in that such materials sometimes have already been proven to be robust enough for serving in applications that require conditions analogous to those that a B-Pillar might need to withstand. Unlike some types of acrylic used in the construction of headlamps and/or tail lamps that tend to be at least partially opaque, however, it will be appreciated that the acrylic material used for a B-Pillar substrate 100 may instead be clear. That is, in certain example embodiments, the acrylic material used for a B-Pillar substrate 100 may instead be constructed from a low- or no-tint acrylic material. For example, in certain example implementations, Altuglas Plexiglas, which is commercially available from, may be used in or as the low- or no-tint acrylic material for the B-Pillar substrate 100.

In certain example implementations, the B-Pillar may be about 3 mm thick, although the thickness may vary in example embodiments, e.g., in dependence on the type of vehicle, molding constraints, etc. The thickness thereof may be reduced to about 2 mm in certain areas in certain example implementations, e.g., to accommodate packaging and/or connection constraints associated with the sheet metal frame of the vehicle. In certain example implementations, the wall thickness may be about 3 mm. Approximately one-quarter inch or 6 mm of B-Pillar may be provided on either side of numbers or other control-related symbols in certain example implementations.

Paint is applied to the back or inner surface of the B-Pillar 100. Any suitable paint may be applied to the back or inner surface of the B-Pillar 100. For example, standard vehicle exterior grade paint commercially available from BASF may be used in connection with certain example implementations.

Symbols such as numbers or graphics are laser etched into the paint and also may be lighted from behind, e.g., via the control electronics and/or other suitable lighting mechanisms (e.g., via LEDs or the like). Thus, the symbols may show through the clear Plexiglas to the exterior of the B-Pillar 100. For example, as shown perhaps best in FIG. 1, numbers 102 are laser etched in the paint so as to show through to the front side of the B-Pillar 100. These numbers 102 define a control area, or area where a user may input codes to achieve a particular function with respect to the vehicle via the control electronics. An indicator 104 also may be provided, e.g., to show that power is received, indicate whether the doors or locked or unlocked, etc. It will be appreciated that other symbols may be used including, for example, any suitable combination of letters, numbers, and icons (such as padlocks, indicator lights, etc.).

Applying the paint to at least the inner surface of the B-Pillar 100 may be advantageous in certain example embodiments. For example, applying paint to the outer surface of the B-Pillar 100 alone may not be robust enough for certain automotive applications, such as those that are exposed to extreme conditions. Thus, applying the paint to at least the inner surface the B-Pillar 100 and then laser etching away symbols may be advantageous in certain example implementations.

An electronic sensor and/or other control electronics (not shown) may be adhered to the back side or inner surface of the B-Pillar 100 in a recess 208 provided therein. In other words, the electronics may be provided “behind” the pillar. The electronic sensor and/or other control electronics may, as alluded to above, provide a touch sensor interface and/or lighting for the numbers, graphics, or other symbols to be illuminated. That is, in certain example embodiments, the symbols may “light up” via the electronics provided behind them, either when touched initially (e.g., to help the user see the control area, potentially in the dark) and/or each time that the control area is touched.

Any suitable electronic sensor and/or other control electronics may be used in connection with the example embodiments described herein. For example, in certain example implementations, an instrument panel switch and module commercially available from Stroneridge Pollak may be used. These and/or other devices may be configured to detect and/or localize a change in temperature proximate to the substrate, thereby effectively interpreting which “buttons” have been pushed. In certain example embodiments, it may be necessary to set the temperature change threshold so that random fluctuations (caused by, for example, rain drops, snow flakes, etc.) are not erroneously detected. Similarly, detection may be disabled once the vehicle has been started.

Using these and/or other techniques, it may be possible to provide a keyless entry system having substantially flush buttons, substantially or completely free from any protrusions, whatsoever, thereby presenting a smooth, continuous surface to the B-Pillar 100.

The electronic sensor and/or other control electronics (not shown) may be adhered to the back side or inner surface of the B-Pillar 100 in the recess 208 using any suitable means. For example, certain example embodiments may include an acrylic-based adhesive tape having a foam core. Such an adhesive advantageously reduces the likelihood of temperature damage and/or also creates an environment substantially impermeable to debris and/or other elements, thereby substantially completely sealing the electronic elements, e.g., in the recess 208. In certain example implementations, an acrylic-based adhesive tape having a foam core commercially available from 3M under the tradename PT1100 may be used.

Testing was performed to determine the most robust attachment system to this paint system, as well as show that acrylic foam tapes are able to keep a water tight seal. Peel testing and ice water shock testing were performed, and the tape tested was 3M PT1100.

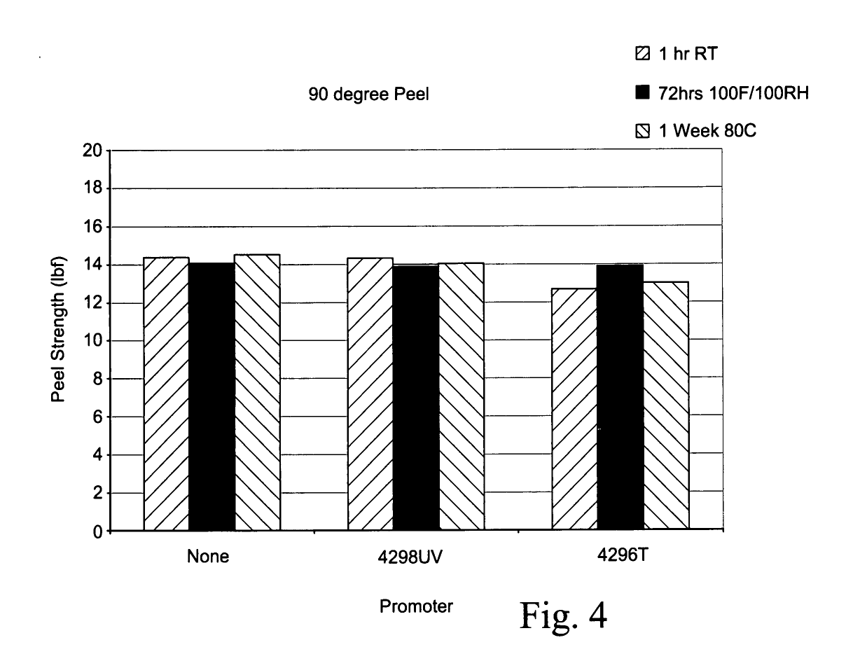

All PT1100 tapes tested were 1.1 mm thick tape and 12.7 mm wide. First, the appliqués were cleaned with a 50:50 mix of isopropyl alcohol and water. Next, the promoter (where applicable) and tape were applied to the part and pressurized with a 15 lb. roller. The samples were pulled at 12 inches per minute after the indicated conditioning. The peel strength for a 90 degree peel at various conditions is shown graphically in FIG. 4. Based on this laboratory testing, it appears that PT1100 may be used in connection with certain example implementations. Ultimate adhesion is achieved to the paint system without the use of a promoter and does not appear to significantly degrade after conditioning.

As noted above, an ice water shock test was performed. In the test system, one appliqué was taped together with another piece of a clear acrylic appliqué. Before joining, a piece of a tissue was put between the two to ensure a failure would be noticed. The assembly was first soaked in a bucket with blue dye for 10 days. No leakage was witnessed. Next, the assembly was put in an oven at 85 degrees Celsius for 1 hour. Then, the part was removed and immediately immersed in ice water at approximately 3 degrees Celsius for 30 minutes. No leakage was witnessed. Based on this laboratory testing, there did not appear to be any significant affect to the adhesion of the tape to either substrate when taken from a hot temperature to an ice water immersion.

The B-Pillar 100 may be connected to the vehicle via any suitable means including, for example, one or more adhesives, one or more locator clips, and/or one or more snap features. For example, a W-clip 106 may be provided on one or both sides of the B-Pillar 100, e.g., to facilitate the locating and/or connection of the B-Pillar 100 to the vehicle. Optionally, one or more locator clips may be provided proximate to the top of the B-Pillar 100 on the interior surface thereof.

The sheet metal frame of the vehicle may include one or more protrusions, and one or more holes may be provided proximate to these protrusions. To accommodate such features of the sheet metal frame of the vehicle, corresponding depressions 204a and 204b may be formed in the inner surface of the B-Pillar 100. Furthermore, snap features 206a and 206b may be respectively provided in the depressions 204a and 204b, e.g., for corresponding with the holes in, or other snap features provided to, the sheet metal frame of the vehicle.

Pull tabs 202a and 202b may be provided to opposing major and/or minor surfaces of the B-Pillar 100. Such pull tabs 202a and 202b may at least initially protect an adhesive (e.g., an adhesive tape) formed thereunder. The pull tabs 202a and 202b may be removed to expose the adhesive (or dual side tape of certain example embodiments). It then may be wetted out to secure the connection of the B-Pillar 100 to the vehicle.

Optionally, a decorative logo 210 may be applied to the inner surface of the B-Pillar 100. The decorative logo 210 may or may not be visible through the paint applied to the inner surface of the B-Pillar 100. The decorative logo 210 may be indicative of the vehicle manufacturer, the B-Pillar supplier, etc.

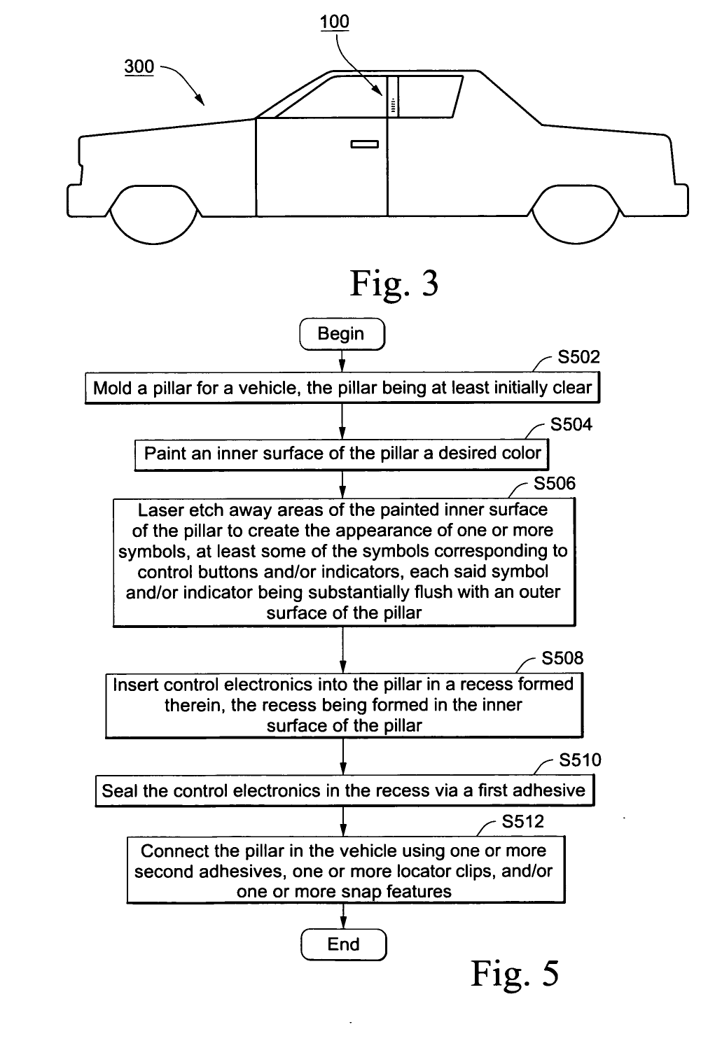

The B-Pillar 100 may thus be connected to a vehicle as shown, for example, in FIG. 3. As will be appreciated, FIG. 3 is a vehicle 300 including a B-Pillar 100 in accordance with an example embodiment.

FIG. 5 is a flowchart showing an illustrative process for making a B-Pillar electronic device in accordance with an example embodiment. In step S502, a pillar (e.g., a B-Pillar) is molded for a vehicle. The pillar is at least initially clear. In step S504, an inner surface of the pillar is painted a desired color. Areas of the painted inner surface of the pillar are laser-etched away to create the appearance of one or more symbols in step S506. At least some of the symbols correspond to control buttons and/or indicators. Each symbol and/or indicator is therefore substantially flush with an outer surface of the pillar. Control electronics are inserted into the pillar in a recess formed therein in step S508. The recess itself is formed in the inner surface of the pillar. The control electronics are sealed in the recess via a first adhesive, which may have a foam core in step S510. In step S512, the pillar is connected to the vehicle using one or more second adhesives, one or more locator clips, and/or one or more snap features.

In one or more steps not shown, the control electronics may be connected to a power source. For example, the control electronics may be connected to the vehicle's LIN bus, one or more batteries, etc.

### Example Performance Requirements

Some of following conditions were tested in accordance with a set of example requirements, both typical of the automotive industry and possible usable in connection with certain example embodiments. It will be appreciated, however, that actual performance and/or actual requirements may vary from the metrics and guidelines respectively provided herein.

In general, the enamel may cure to a presentable, serviceable film showing no craters, pinholes seediness or abnormal roughness. In terms of film properties and the adhesion thereof, it would be advantageous to reduce the amount of flaking and/or chipping. A number of resistance properties may be specified including, for example, minimum water resistance, weathering resistance, and water resistance after weathering. To this end, one test for minimum water resistance involves 96 hour immersion in distilled or deionized water maintained at 100±2° F. After immersion, an X is scribed through the enamel to the substrate, the scribed area is dried, and ESF-MSG48 tape is applied to the scribed area with firm thumb pressure. The tape is remove by pulling one end at a 90° angle at a moderate speed. The test may be passed by having no or substantially no blistering, or removal of paint, with no or substantially no evidence of blistering or removal of paint beyond 1/16 inch from any scribe line.

Two tests for weathering resistance involve Accelerated Weathering (e.g., 400 hour weatherometer exposure) and Florida Exposure (e.g., 2 months minimum exposure at 45° facing South in the Miami, Fla. Area). The goals of these tests include no or substantially no checking, color or gloss change greater than an approved master sample, although at least some blistering or loss of adhesion is allowed. A test for water resistance after weathering involves 400 hour weatherometer exposure and subjecting the same to 24 hour water resistance (e.g., using the above-described test(s)). Such a test may be considered successful if there is no or substantially no evidence of blistering or removal of paint beyond ⅛ inch from any scribe line.

It would be advantageous to maintain humidity aging by having the function, margins, and flushness of the exterior system assembly remain within design tolerances after a minimum of 240 hours of humidity exposure. Furthermore, painted components may show no or substantially no visible evidence of cracking or blistering when observed with the unaided eye from a distance of 300±30 mm at 23° C.±2° C. Additional degradation of paint adhesion may be reduced, and both painted and mold-in-color components may show no or substantially no color change.

In terms of heat age exposure to the exterior, parts or surrogate samples may, after 336 hours of dry heat at 80° C.±2C° C., show no or substantially no color change in excess of AATCC (American Association of Textile Chemists and Colorists) Gray Scale Rating of 4, with no or substantially no visible cracks or blisters, delamination, or warpage, when observed with the unaided eye from a distance of 300±30 mm at 23° C.±2° C. Similarly, no or substantially no polymer reversion may be evident, and/or material incompatibility such as softening of a coating or adhesive may not be evident.

As is conventional, environmental performance for plastic components including all radiator grilles and exterior ornamentation subsystem components advantageously will not exhibit permanent distortion greater than 0.5 mm, paint crazing, or electroplate cracking following exposure. This may be tested using 5 cycles of the following:
3 hours at 80° C.±2° C.
1 hour at 24° C.±2° C. AND 5±5% RH
3 hours at −40° C.±2° C.
1 hour at 24° C.±2° C. AND 50±5% RH
16 hours at 38° C.±2° C., and
95±5% RH

Although certain example embodiments have been described as relating to a B-Pillar, the present invention is not so limited. For example, the electronic control device and/or other techniques may be applied to other parts or components of a vehicle. For example, an electronic control device may be located in other pillars (e.g., an A-Pillar, C-Pillar, etc.) in addition to, or rather than, in the B-Pillar. Furthermore, the electronic control devices may be located on doors, e.g., proximate to where current lock and key mechanisms are disposed. It also will be appreciated that, as noted above, various designs for the symbols (e.g., numbers, letters, icons, graphics, etc.) may be used; thus, the present invention is not limited to any particular arrangement or inclusion of particular symbols. Still further, it will be appreciated that the electronic control devices of certain example embodiments may perform a variety of functions including, for example, locking/unlocking doors, opening trunk lids, opening gas cover doors, starting the vehicles, turning on lights, adjusting seats, etc.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of making an electronic control device for a vehicle, the method comprising:
molding a pillar, the pillar being at least initially clear;
painting an inner surface of the pillar a desired color;
laser etching away areas of the paint from the inner surface of the pillar to form one or more symbols, at least some of said symbols corresponding to control buttons and/or indicators, each said symbol being substantially flush with an outer surface of the pillar;
inserting control electronics into a recess formed in the pillar, the recess being formed in the inner surface of the pillar; and
sealing the control electronics in the recess via an adhesive.

2. The method of claim 1, wherein the pillar is a B-Pillar.

3. The method of claim 1, further comprising connecting the pillar to the vehicle using one or more second adhesives, one or more locator clips formed on the pillar, and/or one or more snap features formed on the pillar configured to engage with corresponding features included on the vehicle.

4. The method of claim 3, further comprising connecting the control electronics to a power supply.

5. The method of claim 4, further comprising enabling control over features of the vehicle in response to a code input via the control buttons via the control electronics.

6. The method of claim 1, wherein the pillar is substantially impermeable with respect to debris and/or other elements.

7. The method of claim 1, wherein the pillar is formed from acrylic.

8. An electronic control device for a vehicle, comprising:
a pillar initially molded clear and having an inner surface thereof painted a desired color, at least some of the paint being etched away to form one or more symbols, at least some of said symbols corresponding to control buttons and/or indicators, a recess being formed in the inner surface of the pillar;
control electronics inserted into the recess, the control electronics being configured to control features of the vehicle in response to a code input using the control buttons via the control electronics; and
an adhesive arranged to seal the control electronics in the recess,
wherein each said symbol is substantially flush with an outer surface of the pillar.

9. The electronic control device of claim 8, wherein the pillar is a B-Pillar.

10. The electronic control device of claim 8, wherein the pillar is formed from acrylic.

11. The electronic control device of claim 8, wherein the electronic control device is connectable to the vehicle via one or more second adhesives, one or more locator clips formed on the pillar, and/or one or more snap features formed on the pillar configured to engage with corresponding features included on the vehicle.

12. The electronic control device of claim 8, wherein the pillar is substantially impermeable with respect to debris and/or other elements.

13. The electronic control device of claim 8, wherein the control electronics are further configured to light up when actuated.

14. The electronic control device of claim 8, wherein the pillar includes one or more recessions respectively corresponding to one or more protrusions formed in a frame of the vehicle.

15. The electronic control device of claim 14, wherein the pillar includes one or more snap features respectively formed in the one or more recessions, the one or more snap features being configured to engage with corresponding features included on the vehicle.

16. A pillar for a vehicle including an electronic control device, the pillar being initially molded clear and having an inner surface thereof painted a desired color, at least some of the paint being etched away to form one or more symbols, at least some of said symbols corresponding to control buttons and/or indicators, the pillar comprising:
a recess being formed in the inner surface of the pillar;
control electronics inserted into the recess, the control electronics being configured to control features of the vehicle in response to a code input using the control buttons via the control electronics; and
an adhesive arranged to seal the control electronics in the recess,
wherein each said symbol is substantially flush with an outer surface of the pillar, and
wherein the pillar is formed from acrylic.

17. The pillar of claim 16, wherein the pillar is a B-Pillar.

18. The pillar of claim 16, further comprising connection features configured to engage with corresponding features included on the vehicle, the connection features comprising one or more second adhesives, one or more locator clips, and/or one or more snap features configured to engage with corresponding features included on the vehicle.

19. The pillar of claim 16, wherein the pillar is substantially impermeable with respect to debris and/or other elements.

20. The pillar of claim 16, further comprising one or more recessions respectively corresponding to one or more protrusions formed in a frame of the vehicle.

21. The pillar of claim 20, wherein the pillar includes one or more snap features respectively formed in the one or more recessions, the one or more snap features being configured to engage with corresponding features included on the vehicle.

22. A vehicle comprising a pillar and an electronic control device for the vehicle, the pillar being initially molded clear and having an inner surface thereof painted a desired color, at least some of the paint being etched away to form one or more symbols, at least some of said symbols corresponding to control buttons and/or indicators, the pillar comprising:
a recess being formed in the inner surface of the pillar;
control electronics inserted into the recess, the control electronics being configured to control features of the vehicle in response to a code input using the control buttons via the control electronics; and
an adhesive arranged to seal the control electronics in the recess,
wherein each said symbol is substantially flush with an outer surface of the pillar, and
wherein the pillar is formed from acrylic.

23. The vehicle of claim 22, wherein the pillar is a B-Pillar.

24. A method of making an electronic control device for a vehicle, the method comprising:
molding a vehicle trim component, the vehicle trim component being at least initially clear;
painting an inner surface of the vehicle trim component a desired color;
laser etching away areas of the paint from the inner surface of the vehicle trim component to form one or more symbols, at least some of said symbols corresponding to control buttons and/or indicators, each said symbol being substantially flush with an outer surface of the vehicle trim component;
inserting control electronics into a recess formed in the vehicle trim component, the recess being formed in the inner surface of the vehicle trim component; and
sealing the control electronics in the recess via an adhesive.
